(19) United States
(12) Patent Application Publication
(10) Pub. No.: US 2026/0117002 A1
(43) Pub. Date: Apr. 30, 2026

(54) METHODS FOR PREPARING CHITOSAN CONJUGATES

(71) Applicant: Nano and Advanced Materials Institute Limited, Hong Kong (CN)

(72) Inventors: Cheuk Ka POON, Hong Kong (CN); Chun Hay KO, Hong Kong (CN); Wing Man CHAN, Hong Kong (CN); Tian LI, Hong Kong (CN); Pak Ho LAU, Hong Kong (CN); Wah Kit CHEUK, Hong Kong (CN)

(21) Appl. No.: 18/932,835

(22) Filed: Oct. 31, 2024

(51) Int. Cl. C08B 37/08

(52) U.S. Cl. CPC C08B 37/003

(57) ABSTRACT

A method for preparing a chitosan conjugate, the method including: contacting chitosan, a dicarboxylic acid, and 4-(4,6-dimethoxy-1,3,5-triazin-2-yl)-4-methyl-morpholinium chloride (DMTMM) in an aqueous solvent thereby forming a reaction mixture including the chitosan conjugate, wherein the chitosan conjugate includes a repeating unit of Formula I,

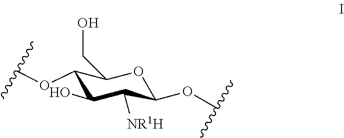

or a conjugate salt thereof, wherein
R¹ is —(C═O)(CH₂)mCO₂H; and
m is a whole number selected from 1-12.

### TECHNICAL FIELD

The present disclosure relates to methods for preparing chitosan conjugates.

### BACKGROUND

Polysaccharides are biopolymers made up of monosaccharide units bonded by glycosidic linkages. The composition of the monosaccharide units define the physical and chemical properties of the polysaccharides formed, such as starch, cellulose, glycogen, dextran, etc, which can have different intrinsic properties. Polysaccharides present a number of chemical functional groups, such as hydroxyl, amino, carboxyl and sulfate groups, etc. These reactive groups enable chemical modifications of the polysaccharides, which can enchance physical-chemical properties like hydrophobicity, water solubility and stimuli responsiveness, which can increase the range of applications of the thus modified polysaccharides, particularly in the field of personal care, medical, agriculture, food packaging and paper/textile. Chemical modification, such as carboxymethylation, (de) acetylation, sulfation and phosphorylation are common approaches to modify polysaccharides. Alternatively, integrating functional macromolecules offer more versatile ways to chemically modify polysaccharides, which can bear features from the macromolecule of interest. This can be achieved by cross-linking, complexation and bioconjugation.

Bioconjugation has become increasingly prevalent in functionalizing polysaccharides. This chemical strategy can utilise the functional groups present in the polysaccharide, which can be covalently fused together with the use of bifunctional/multifunctional cross-linkers, or coupling reagents to create new derivatives. Functional groups, such as primary amines, sulfhydryls, and carbonyls, present on polysaccharides are common targets for bioconjugation. While bioconjugation of polysaccharides is generally carried out in organic solvent due to water-insolubility of the biopolymers, water-based bioconjugation is also possible with the employment of water-soluble cross-linkers or coupling reagents for modifying polysaccharides which are soluble in aqueous solutions.

Chitosan is a common polysaccharide with functional groups accessible for chemical modification. It is copolymer of randomly distributed β-(1-4)-linked D-glucosamine units (deacetylated) and N-acetyl-D-glucosamine units (acetylated) from deacetylation of chitin, a process which reveals primary amino groups on the glucosamine backbone. Such chemical features enable versatile chemical modifications for applications in papers, paints, food, pharmaceutical products and textiles.

Water solubility of chitosan is predominantly influenced by its molecular weight and degree of deacetylation. Typical water-soluble forms of chitosan exists as oligosaccharides, which are oligomers of glucosamine units with degree of polymerization of less than 50-55 and molecular weight of less than 10,000 amu. Native chitosan with molecular weight greater than 10,000 amu can only be solubilized in water in the presence of an organic acid, such as acetic acid, lactic acid and citric acid; or inorganic acid, such as hydrochloric acid and phosphoric acid. The amino groups on the glucosamine backbone of chitosan are protonated in acidic environment, creating cationic charges on the polysaccharide for solubilization in water. Removal of acidic component, on the other hand, makes chitosan become water insoluble due to transformation of amino groups from cationic to uncharged states. While native chitosan is also insoluble in a number of organic solvents such as dimethylformamide (DMSO), acetone, ethanol and dichloromethane, the application of chitosan is limited to water-based solution in the presence of acidic additives, which may give rise to an acidic odor in the final product or require removal of acidic component. Development of new chitosan conjugates with improved water solubility is therefore needed to expand its range of applications.

Chitosan possesses reactive functional groups for chemical modification. Among them, primary amino groups presented on the deacetylated glucosamine units of the polymer backbone enable chemical modification with carboxyl-bearing molecules via amidation, which forms covalent linkages for durable attachment with the employment of coupling reagent and coupling additive. EDC-NHS carbodiimide coupling reaction is a well-established chemical strategy for water-based amide-forming bioconjugation. The conjugation recruits water-soluble coupling agent 1-(3-dimethylaminopropyl)-3-ethylcarbodiimide (EDC) and optionally N-hydroxysuccinimide (NHS). During the reaction, carboxylic acid groups are first activated by EDC to form O-acylurea intermediates, which are reactive towards primary amines. However, O-acylurea intermediates are largely unstable due to rapid hydrolysis by water. Introduction of NHS to the system can stabilize the activated carboxyl group and reacts much more rapidly with the amine than water to achieve higher yield of amide conjugates. EDC/NHS reaction can result in side products including N-acylurea, O-acylurea and regenerated carboxylic acid. The use of N-hydroxysulfosuccinimide sodium salt (Sulfo-NHS) in place of NHS can improve the amidation efficiency by extending the half-life and improving the solubility of amine-reactive ester in aqueous solution. In some instance, water-miscible organic solvent is added to the reaction to reduce unwanted hydrolysis reaction.

Although EDC/(sulfo-) NHS carbodiimide chemistry is a well-established general approach to modify chitosan in water-based reaction, there are a number of limitations associated with the reaction. Typically, the chitosan used as starting material exists in low molecular weight and is soluble in water. On the other hand, reaction with water-insoluble chitosan (Molecular weight >100,000 amu) requires addition of acid to aid solubilization of the chitosan in water, while the reaction will also need to be maintained at pH 4.5-7.5 for efficient carboxyl activation and conjugation. Purification of crude product typically involves dialysis to remove by-products followed by lyophilization, which take more than few days to complete and make large scale production impractical. In addition, both NHS and sulfo-NHS are very costly (USD5,000-6,000/kg and USD5,500-10,000/kg, respectively). They are more applicable for small-scale reactions, especially in peptide and protein modification.

Apart from EDC/(sulfo-) NHS, aqueous based amide bond formation can also be mediated by 4-(4,6-dimethoxy-1,3,5-triazin-2-yl)-4-methyl-morpholinium chloride (DMTMM) due to its low cost and good reactivity in water.

Nevertheless, there is still a need in the art to develop improved methods for preparing chitosan conjugates that overcome at least some of the disadvantages known in the art.

### SUMMARY

Disclosed herein is a facile approach to prepare a chitosan conjugate via water-based acylation. The amidation will recruit DMTMM to conjugate a dicarboxylic acid linker adipic acid to amino groups on glucosamine backbone of chitosan in water-based solvent at room temperature (FIG. 1). The conjugation process can be carried out by simple stirring within four hours at room temperature. The degree of conjugation can be readily controlled by modifying reagent stoichiometry, reaction time and reagent concentrations. Purification of the chitosan conjugate can be achieved through solvent precipitation, followed by drying to remove the residual solvent. The whole production process can be completed within 1-1.5 days. Advantageously, the resulting chitosan-adipic acid conjugate did not show crosslinking between chitosan chains. The conjugate also demonstrated good solubility in acidic and neutral aqueous solution, but remained insoluble in alkaline solution.

In first aspect, provided herein is a method for preparing a chitosan conjugate, the method comprising: contacting chitosan, a dicarboxylic acid, and 4-(4,6-dimethoxy-1,3,5-triazin-2-yl)-4-methyl-morpholinium chloride (DMTMM) in an aqueous solvent thereby forming a reaction mixture comprising the chitosan conjugate, wherein the chitosan conjugate comprises a repeating unit of Formula I,

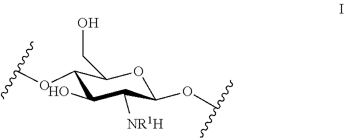

or a conjugate salt thereof, wherein
R¹ is —(C═O)(CH₂)mCO₂H; and
m is a whole number selected from 1-12.

In certain embodiments, the dicarboxylic acid and DMTMM are present in the aqueous solvent at a molar ratio of 2-6:1, respectively.

In certain embodiments, the dicarboxylic acid and DMTMM are present in the aqueous solvent at a molar ratio of 2.5-3.5:1, respectively.

In certain embodiments, the chitosan, the dicarboxylic acid, DMTMM, and the aqueous solvent are contacted at a mass ratio of 0.5-2.5:0.5-3:0.5-2:93-98.5, respectively.

In certain embodiments, the chitosan, the dicarboxylic acid, and the aqueous solvent are contacted at a mass ratio of about 2 to about 2.4 to about 1.6 to about 94, respectively.

In certain embodiments, contacting comprises contacting the chitosan, the dicarboxylic acid, and the DMTMM at 20-40° C. for 1-20 hours.

In certain embodiments, the step of contacting comprises contacting the chitosan, the dicarboxylic acid, and the DMTMM at about 25° C. for about four hours.

In certain embodiments, contacting comprises contacting chitosan and the dicarboxylic acid in the aqueous solvent thereby forming a first solution and contacting the first solution and DMTMM.

In certain embodiments, contacting comprises contacting a chitosan dispersion, a dicarboxylic acid dispersion, and a DMTMM dispersion thereby forming the reaction mixture, wherein the chitosan dispersion comprises chitosan and the aqueous solvent, the dicarboxylic acid dispersion comprises the dicarboxylic acid and the aqueous solvent, and the DMTMM dispersion comprises DMTMM and the aqueous solvent.

In certain embodiments, the step of contacting comprises contacting the chitosan dispersion, the dicarboxylic acid dispersion, and the DMTMM dispersion at 20-40° C. for 1-20 hours.

In certain embodiments, the step of contacting comprises contacting the chitosan dispersion, the dicarboxylic acid dispersion, and the DMTMM dispersion at about 25° C. for about four hours.

In certain embodiments, m is 2-4.

In certain embodiments, m is 4.

In certain embodiments, the chitosan conjugate further comprises a repeating unit of Formula II and optionally a repeating unit of Formula III,

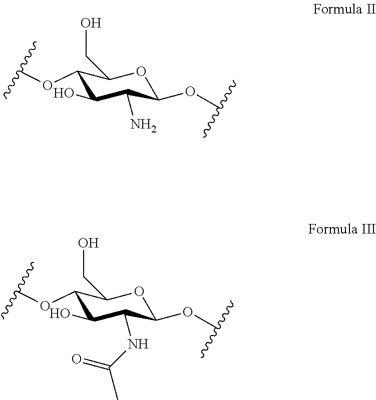

In certain embodiments, the repeating unit of Formula I accounts for 20-40% based on a total number of the repeating units of Formula I, repeating units of Formula II, and optionally the repeating units of Formula III in the chitosan conjugate.

In certain embodiments, the chitosan conjugate has a weight average molecular weight of about 300,000 amu.

In certain embodiments, the chitosan conjugate has a polydispersity index (PDI) of about 1.52.

In certain embodiments, the method further comprises the step of contacting the reaction mixture with an organic solvent thereby precipitating the chitosan conjugate and collecting the precipitated chitosan conjugate.

In certain embodiments, the organic solvent is selected from the group consisting of an alcohol, a ketone, and mixtures thereof.

### BRIEF DESCRIPTION OF DRAWINGS

The appended drawings, where like reference numerals refer to identical or functionally similar elements, contain figures of certain embodiments to further illustrate and clarify the above and other aspects, advantages, and features of the present disclosure. It will be appreciated that these drawings depict exemplary embodiments and as such are not intended to limit the scope of this disclosure. The methods described herein will be described and explained with additional specificity and detail through the use of the accompanying drawings.

FIG. 1 depicts a chemical structure of chitosan conjugate.

FIG. 2 shows schematic images and an exemplary process of the reaction and purification of chitosan-adipic acid conjugate synthesized from DMTMM coupling reaction.

FIG. 3 depicts Fourier-transform infrared spectroscopy (FTIR) spectra of adipic acid, chitosan and chitosan-adipic acid conjugate prepared by DMTMM coupling reaction.

FIG. 4 shows the formation of gel from DMTMM coupling reaction in reaction EP1306-80b.

FIG. 5 shows the comparative FTIR spectra of chitosan-adipic conjugate from optimization of DMTMM coupling reaction EP1306-80c, EP1306-81, EP1306-82a and EP1306-82b.

FIG. 6 depicts size exclusion chromatography (SEC) chromatograms showing traces for chitosan and chitosan-adipic acid conjugate prepared by DMTMM coupling reaction (0.5 M acetic acid, 30° C.).

FIG. 7 shows the comparative ¹H-NMR spectra (500 MHz) of unreacted chitosan, unreacted adipic acid and chitosan-adipic acid conjugate synthesized by DMTMM coupling (The acetylated-glucosamine unit on chitosan and chitosan-adipic acid conjugate are not presented).

FIG. 8 shows a ¹H-NMR spectrum (500 MHz) of chitosan-adipic acid conjugate synthesized by DMTMM coupling (The acetylated-glucosamine unit on chitosan conjugate is not presented).

FIG. 9 shows comparative images of solubility test of chitosan-adipic acid conjugate prepared by DMTMM coupling reaction in acidic aqueous (pH=2), water (pH=7), alkaline aqueous (pH=9 and 12).

FIG. 10 shows an exemplary experimental setup of 1 kg reaction of chitosan-adipic acid conjugate synthesized from DMTMM coupling reaction.

FIG. 11 shows the comparative FTIR spectra of chitosan-adipic conjugate from 100 g, 500 g and 1 kg reaction scale.

FIG. 12 shows the comparative FTIR spectra of chitosan-adipic conjugate isolated from different reaction time points of DMTMM coupling reaction.

FIG. 13 depicts a proposed synthetic route for preparing chitosan-adipic acid conjugate by DMTMM coupling reaction according to certain embodiments described herein.

### DETAILED DESCRIPTION

### Definitions

The definitions of terms used herein are meant to incorporate the present state-of-the-art definitions recognized for each term in the field of biotechnology. Where appropriate, exemplification is provided. The definitions apply to the terms as they are used throughout this specification, unless otherwise limited in specific instances, either individually or as part of a larger group.

Throughout this specification, unless the context requires otherwise, the word “comprise” or variations such as “comprises” or “comprising”, will be understood to imply the inclusion of a stated integer or group of integers but not the exclusion of any other integer or group of integers. It is also noted that in this disclosure and particularly in the claims and/or paragraphs, terms such as “comprises”, “comprised”, “comprising” and the like can have the meaning attributed to it in U.S. Patent law; e.g., they can mean “includes”, “included”, “including”, and the like; and that terms such as “consisting essentially of” and “consists essentially of” have the meaning ascribed to them in U.S. Patent law, e.g., they allow for elements not explicitly recited, but exclude elements that are found in the prior art or that affect a basic or novel characteristic of the present invention.

Furthermore, throughout the specification and claims, unless the context requires otherwise, the word “include” or variations such as “includes” or “including”, will be understood to imply the inclusion of a stated integer or group of integers but not the exclusion of any other integer or group of integers.

The use of the singular herein includes the plural (and vice versa) unless specifically stated otherwise. In addition, where the use of the term “about” is before a quantitative value, the present teachings also include the specific quantitative value itself, unless specifically stated otherwise. As used herein, the term “about” refers to a ±10%, ±7%, ±5%, ±3%, ±1%, or ±0% variation from the nominal value unless otherwise indicated or inferred.

Provided herein is a method for preparing a chitosan conjugate, the method comprising: contacting chitosan, a dicarboxylic acid, and 4-(4,6-dimethoxy-1,3,5-triazin-2-yl)-4-methyl-morpholinium (DMTMM) in an aqueous solvent thereby forming a reaction mixture comprising the chitosan conjugate, wherein the chitosan conjugate comprises a repeating unit of Formula I,

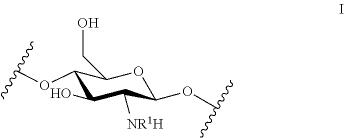

or a conjugate salt thereof, wherein
R¹ is —(C═O)(CH₂)mCO₂H; and
m is a whole number selected from 1-12.

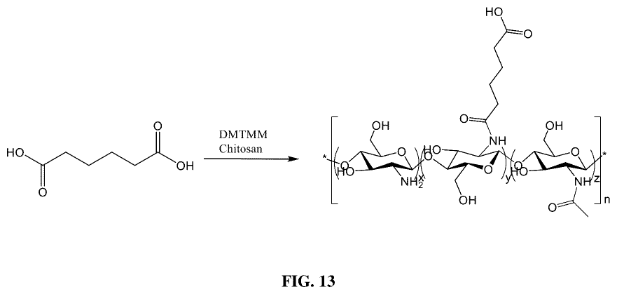

FIG. 13 provides a schematic illustration of an exemplary reaction between chitosan and adipic acid in accordance with certain embodiments described herein.

Chitosan is a linear polysaccharide comprising randomly distributed D-glucosamine repeating units (Formula II) and depending on the degree of deacetylation optionally acetyl-D-glucosamine repeating units (Formula III):

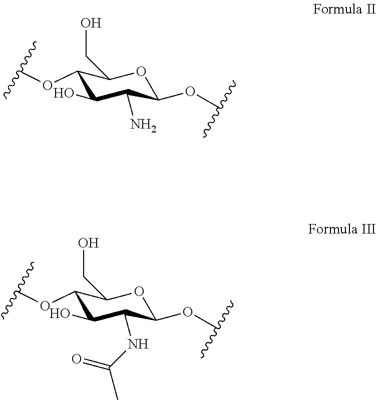

The chitosan can comprise between 0.01-20%, 0.5-20%, 1-20%, 5-20%, 10-20%, 15-20%, 1-15%, 1-10%, 5-15%, or 5-10% of repeating unit of Formula III (based on the total number of repeating units of Formula II and repeating units of Formula III in the chitosan). In certain embodiments, the repeating unit of Formula III accounts for about 5% to about 10% of the repeating units in the chitosan.

The chitosan can have a weight average molecular weight of 100,000-300,000 amu or 180,000-260,000 amu. The degree of deacetylation of the chitosan can range from 50-100%, 70-100%, 80-100%, or 80-95%.

DMTMM is an organic triazine commonly used for activation of carboxylic acids and commercially available as the chloride or tetrafluoroborate salt. However, the present disclosure contemplates all salts of DMTMM including, but not limited to, chloride, bromide, iodide, nitrate, tetrafluoroborate, and hexafluorophosphate salts. In certain embodiments, the DMTMM chloride is used in the methods described herein.

The dicarboxylic acid can be represented by the chemical formula HO₂C(CH₂)ₘCO₂H, wherein m is a whole number selected from 1-12. 1-11, 1-10, 1-9, 1-8, 1-7, 1-6, 1-5, 1-4, 1-3, 1-2, 2-6, or 3-5. In certain embodiments, the dicarboxylic acid is malonic acid (propanedioic acid), succinic acid (butanedioic acid), or glutaric acid (pentanedioic acid), or adipic acid (hexanedioic acid), or pimelic acid (heptanedioic acid), suberic acid (octanedioic acid), sebacic acid (decanedioic acid), undecanedioic acid, dodecanedioic acid, brassylic acid (tridecanedioic acid), or a combination thereof. In certain embodiments, the dicaboxylic acid is adipic acid (m is 4).

The concentration of chitosan in the aqueous solution can range from 0.5-2.5% w/w, 1-2.5% w/w, 1.5-2.5% w/w, 2-2.5% w/w, 0.5-2.0% w/w, 0.5-1.5% w/w, 0.5-1% w/w, 1.6-2.4% w/w, 1.7-2.3% w/w, 1.8-2.2% w/w, or 1.9-2% w/w relative to the total weight of the chitosan, dicarboxylic acid, DMTMM, and aqueous solution. In certain embodiments, the concentration of chitosan in the aqueous solution is about 2% w/w relative to the total weight of the chitosan, dicarboxylic acid, DMTMM, and aqueous solution.

The concentration of dicarboxylic acid in the aqueous solution can range from 1-3% w/w, 1.5-3% w/w, 2-3% w/w, 2.5-3% w/w, 1-2.5% w/w, 1-2% w/w, 1-1.5% w/w, 2-2.8% w/w, 2.1-2.7% w/w, 2.2-2.6% w/w, or 2.3-2.5% w/w relative to the total weight of the chitosan, dicarboxylic acid, DMTMM, and aqueous solution. In certain embodiments, the concentration of dicarboxylic acid in the aqueous solution is about 2.4% w/w relative to the total weight of the chitosan, dicarboxylic acid, DMTMM, and aqueous solution.

The concentration of DMTMM in the aqueous solution can range from 1-3% w/w, 1.5-3% w/w, 2-3% w/w, 2.5-3% w/w, 1-2.5% w/w, 1-2% w/w, 1-1.5% w/w, 1.2-2% w/w, 1.3-1.9% w/w, 1.4-1.8% w/w, or 1.5-1.7% w/w relative to the total weight of the chitosan, dicarboxylic acid, DMTMM, and aqueous solution. In certain embodiments, the concentration of DMTMM in the aqueous solution is about 1.6% w/w relative to the total weight of the chitosan, dicarboxylic acid, DMTMM, and aqueous solution.

The dicarboxylic acid and DMTMM can be present in the aqueous solvent at a molar ratio of 2-6:1, 2-5.5:1, 2-5:1, 2-4.5:1, 2-4:1, 2-3.5:1, 2-3:1, 2-2.5:1, 2.5-6:1, 3-6:1, 3.5-6:1, 4-6:1, 4.5-6:1, 5-6:1, 5.5-6:1, or 2.5-3.5:1, respectively. In certain embodiments, the dicarboxylic acid and DMTMM are present in the aqueous solvent at a molar ratio at about 2.5 to about 1, about 3.5 to about 1 or about 2.5-3.5 to about 1.

The rate of grafting can be controlled by adjusting the mass ratio of the chitosan, the dicarboxylic acid, DMTMM, and the aqueous solvent. In certain embodiments, the chitosan, the dicarboxylic acid, and, and the aqueous solvent are contacted at a mass ratio of 0.5-2.5:0.5-3:0.5-2:93-98.5 or 1.5-2:2-3:1.5-2:93-95, respectively. Advantageously, no intermolecular crosslinking between chitosan is not observed when the chitosan, the dicarboxylic acid, and, and the aqueous solvent are contacted at a mass ratio of about 2 to about 2.4 to about 1.6 to about 94, respectively.

The coupling reaction between chitosan and the dicarboxylic acid can be conducted in an aqueous solvent. In certain embodiments, the aqueous solvent comprises water or consists of water. In other embodiments, the aqueous solvent comprises water and one or more organic solvents selected from the group consisting of alcohols, such as methanol, ethanol, isopropanol, and the like, ethers, such as tetrahydrofuran, dioxane, and the like, and ketones, such as acetone, methyl ethyl ketone, and the like. In certain embodiments, the aqueous solvent is water.

Contacting the chitosan, the dicarboxylic acid, and the DMTMM in the aqueous solvent can comprise contacting the chitosan, the dicarboxylic acid, and the DMTMM in the aqueous solvent at 20-40° C., 20-35° C., 20-30° C., or 20-25° C. In certain embodiments, contacting the chitosan, the dicarboxylic acid, and the DMTMM in the aqueous solvent is conducted at room temperature, e.g., about 25° C.

Contacting the chitosan, the dicarboxylic acid, and the DMTMM in the aqueous solvent can comprise contacting the chitosan, dicarboxylic acid, and the DMTMM in the aqueous solvent for 1-20 hours, 1-16 hours, 1-15 hours, 1-14 hours, 1-13 hours, 1-12 hours, 1-11 hours, 1-10 hours, 1-9 hours, 1-8 hours, 1-7 hours, 1-6 hours, 1-5 hours, 1-4 hours, 1-3 hours, 1-2 hours, 2-6 hours, or 3-5 hours. In certain embodiments, the chitosan, dicarboxylic acid, and the DMTMM are contacted in the aqueous solvent for about 4 hours. In certain embodiments, the chitosan, dicarboxylic acid, and the DMTMM are contacted in the aqueous solvent for less than 1 hour, less than 2 hours, less than 3 hours, less than 4 hours, less than 5 hours, less than 6 hours, less than 7 hours, less than 8 hours, less than 9 hours, less than 10 hours, less than 11 hours, less than 12 hours, less than 13 hours, or less than 14 hours.

The order of addition of the chitosan, the dicarboxylic acid, and the DMTMM and aqueous solvent can be varied. The present disclosure contemplates all orders of addition including simultaneous and/or sequential addition of each/all materials. In certain embodiments, the dicarboxylic acid is first combined with the aqueous solvent, followed by addition of the chitosan and then addition of the DMTMM. In certain embodiments, a dicarboxylic acid dispersion is combined with a chitosan dispersion followed by combining a DMTMM dispersion, wherein the dicarboxylic acid dispersion comprises the dicarboxylic acid and aqueous solvent, the chitosan dispersion comprises chitosan and the aqueous solvent, and the DMTMM dispersion comprises DMTMM and the aqueous solvent.

The method described herein can further comprise purification and/or isolation of the chitosan conjugate. In certain embodiments, the method further comprises contacting the reaction mixture with an organic solvent thereby precipitating the chitosan conjugate, collecting the precipitated chitosan conjugate, and optionally washing the precipitated chitosan conjugate with an organic solvent. The organic solvent used to precipitate the chitosan conjugate can be one more solvents selected from the group consisting of alcohols, such as methanol, ethanol, isopropanol, and the like, ethers, such as tetrahydrofuran, dioxane, and the like, and ketones, such as acetone, methyl ethyl ketone, and the like. The organic solvent used to wash the precipitated chitosan conjugate can be one more solvents selected from the group consisting of alcohols, such as methanol, ethanol, isopropanol, and the like, ethers, such as tetrahydrofuran, dioxane, and the like, and ketones, such as acetone, methyl ethyl ketone, and the like.

In certain embodiments, the chitosan conjugate further comprises D-glucosamine repeating units (Formula II) and optionally acetyl-D-glucosamine repeating units (Formula III):

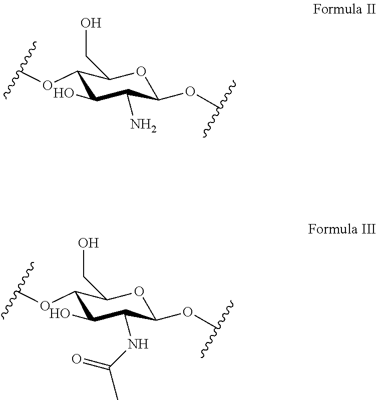

The repeating unit of Formula I can account for between 0.5-50%, 1-50%, 5-50%, 5-45%, 1-45%, 1-40%, 5-35%, 6-35%, 6-34%, 7-34%, 7-30%, 7-25%, 7-20%, 7-15%, 7-10%, 7-9%, 10-35%, 15-35%, 20-35%, 25-35%, 26-35%, 27-35%, 28-35%, 25-34%, or 28-34% of the repeating units in the chitosan conjugate (based on the total number of repeating units of Formula I, repeating units of Formula II, and repeating units of Formula III). In certain embodiments, the repeating unit of Formula I accounts for about 28-34% of the repeating units in the chitosan conjugate. In certain embodiments, the repeating unit of Formula I accounts for about 25% to about 34% or about 28 to about 34% of the repeating units in the chitosan conjugate.

The chitosan conjugate can comprise between 30-70%, 35-70%, 40-70%, 45-70%, 50-70%, 55-70%, 60-70%, 65-70%, 30-65%, 30-60%, 30-55%, 30-50%, 30-45%, 30-40%, 30-35%, or 51-70% of repeating unit of Formula II (based on the total number of repeating units of Formula I, repeating units of Formula II, and repeating units of Formula III). In certain embodiments, the repeating unit of Formula II accounts for about 51% to about 70% of the repeating units in the chitosan conjugate.

The chitosan conjugate can comprise between 0.01-20%, 0.5-20%, 1-20%, 5-20%, 10-20%, 15-20%, 1-15%, 1-10%, 5-15%, or 5-10% of repeating unit of Formula III (based on the total number of repeating units of Formula I, repeating units of Formula II, and repeating units of Formula III). In certain embodiments, the repeating unit of Formula III accounts for about 5% to about 10% of the repeating units in the chitosan conjugate.

FIG. 1 illustrates an exemplary chitosan conjugate prepared in accordance with the methods described herein, wherein R¹ is as defined herein, x can be 3-7, y can be 0.5-5, z can be 0-2, and n can be 10-500.

The chitosan conjugate can have a weight average molecular weight of 10,000-400,000 amu, 50,000-400,000 amu, 100,000-400,000 amu, 150,000-400,000 amu, 200,000-400,000 amu, 250,000-400,000 amu, 300,000-400,000 amu, 350,000-400,000 amu, 100,000-350,000 amu, 100,000-300,000 amu, 100,000-250,000 amu, 100,000-200,000 amu, 100,000-150,000 amu, 150,000-400,000 amu, 200,000-350,000 amu, or 250,000-300,000 amu. In certain embodiments, the chitosan conjugate has a weight average molecular weight of about 260,000 amu.

The chitosan conjugate can have a PDI of about 1.1-2, 1.2-2, 1.3-2, 1.4-2, 1.5-2, 1.6-2, 1.7-2, 1.82, 1.9-2, 1.1-2, 1.1-1.9, 1.1-1.8, 1.1-1.7, 1.1-1.6, 1.1-1.5, 1.1-1.4, 1.1-1.3, 1.1-1.2, 1.1-1.9, 1.2-1.8, 1.3-1.7, or 1.4-1.6. In certain embodiments, the chitosan has a PDI of about 1.52.

### EXAMPLES

### Example 1—Preparation of Chitosan-Adipic Acid Conjugate within 100 g Reaction Scale by DMTMM Coupling Reaction

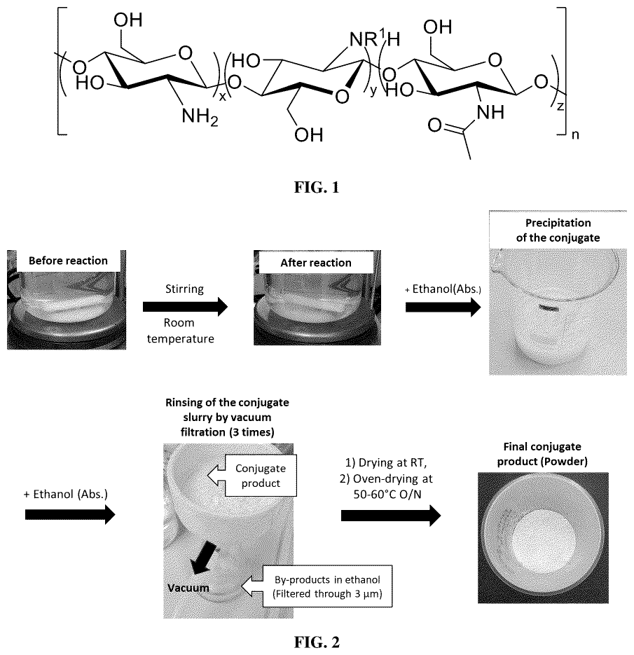

Chitosan (degree of deacetylation=80-95%) and adipic acid was dissolved in water by stirring at room temperature for at least 30 minutes. DMTMM was added to the chitosan/adipic acid solution and stirred at room temperature for 4 hours. Composition of the reactions is summarized in Table 1. At the end of mixing, the formed chitosan-adipic acid conjugate was purified and obtained from ethanol precipitation. Acetone, isopropanol, or methanol were also applicable for purification of precipitation. The resulting residue was dried at room temperature, followed by 50-60° C. to obtain a white powder (FIG. 2). Successful conjugation was monitored by attenuated total reflectance-Fourier transform infrared (ATR-FTIR) spectroscopy. Chemical structure of the chitosan conjugate was analyzed by ¹H-NMR (500 MHz, D₂O): δ (ppm) 1.51 (s, 4H, adipic acid [CH₂CH₂] backbone), 2.17 (s, 4H, adipic acid CH₂ groups), 3.02 (s, 1H, —CH—NH₂ GlcN backbone), 3.49-3.88 (m, 5H, GlcN and conjugated GlcN backbone), 4.53 (m, 1H, glycosides with D₂O).

TABLE 1
The wt. % of reactants in preparation of chitosan-
adipic acid conjugate within 100 g reaction scale.

| | Chitosan | Adipic acid | DMTMM | Water | Product |
|---|---|---|---|---|---|
| Reaction # | (%) | (%) | (%) | (%) | yield (%) |
| EP1306-80b | 2.0 | 0.8 | 0.6 | 96.6 | N/A |
| EP1306-80c | 2.0 | 0.8 | 0.1 | 97.1 | N/A |
| EP1306-81 | 2.0 | 1.6 | 0.8 | 95.6 | 75-80 |
| EP1306-82a | 2.0 | 2.4 | 0.8 | 94.8 | 75-80 |
| EP1306-82b | 2.0 | 2.4 | 1.6 | 94.0 | 75-80 |

### 1.2 Elucidation of the Resulting Chitosan-Adipic Acid Conjugate

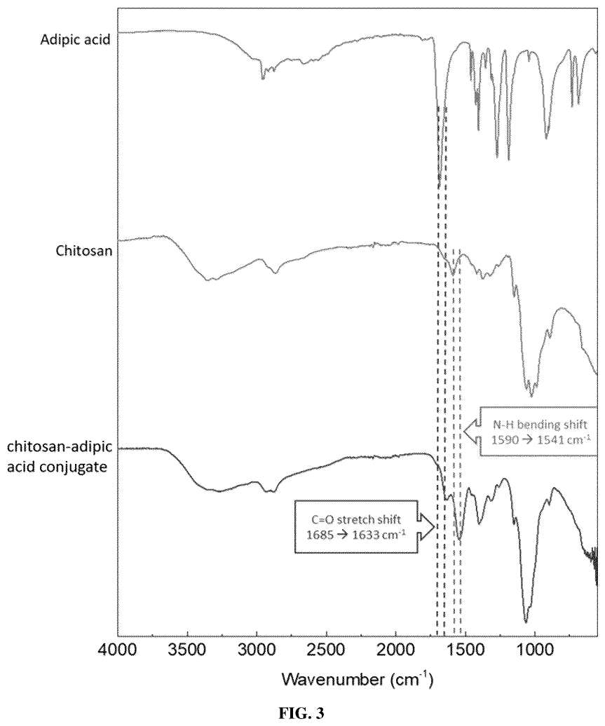

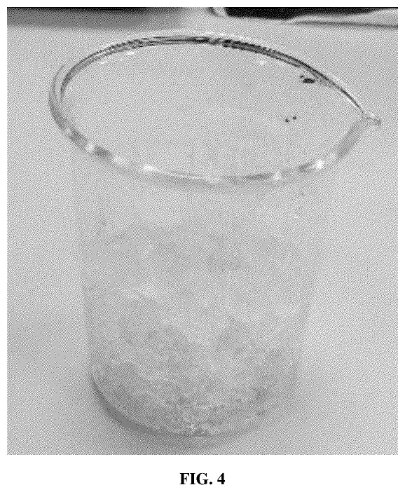

FIG. 3 shows the FTIR spectrum of adipic acid, chitosan, and purified chitosan-adipic acid conjugate (The acetylated-glucosamine unit on chitosan and chitosan-adipic acid conjugate are not presented). Successful grafting of adipic acid to chitosan was evident by the presence of C═O stretch at 1633 cm⁻¹ and amide N—H bending at 1541 cm⁻¹ on the spectrum of the conjugate.

In comparison with C═O signals at 1685 cm⁻¹ and N—H signal at 1590 cm⁻¹ from unreacted adipic acid and chitosan, respectively, the C═O stretch and amide NH bend signals from the conjugate demonstrated shifting to lower wavenumbers from corresponding peaks. The shifting of the signals suggested the formation of the conjugate from the starting materials.

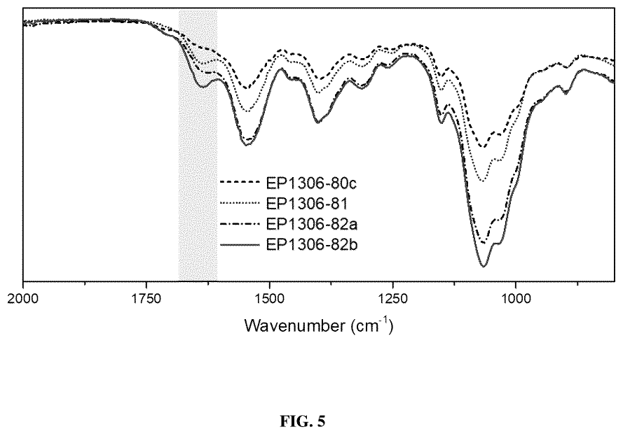

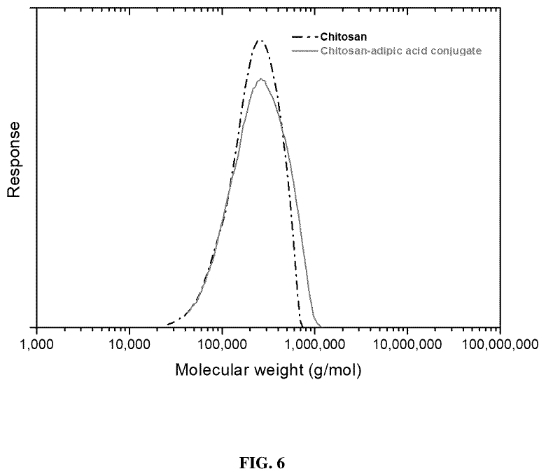

One-pot reactions were carried out in EP1306-80b, EP1306-80c, EP1306-81, EP1306-82a and EP1306-80b. Reaction EP1306-80b resulted in gel formation (FIG. 4). The reaction remained as homogeneous solution when DMTMM content was decreased to 0.1% in reaction EP1306-80c. However, the purified product did not give free carboxyl signals at 1630-1660 cm⁻¹ (C═O stretch, highlighted region) on the FTIR spectrum (FIG. 5), suggesting unsuccessful conjugation (Short dash line). Increasing adipic acid to 1.6% and DMTMM to 0.8% in reaction EP1306-81 improved the conjugation as evident by the appearance of free carboxyl signal at 1637 cm⁻¹ on the FTIR spectrum (Short dot line). Increasing adipic acid content to 2.4% and doubling the DMTMM content to 1.6% in reaction EP1306-82b gave significant free carboxyl signal on FTIR spectrum (Solid line). Reaction EP1306-82b was selected as the optimal conditions to produce chitosan-adipic acid conjugate.

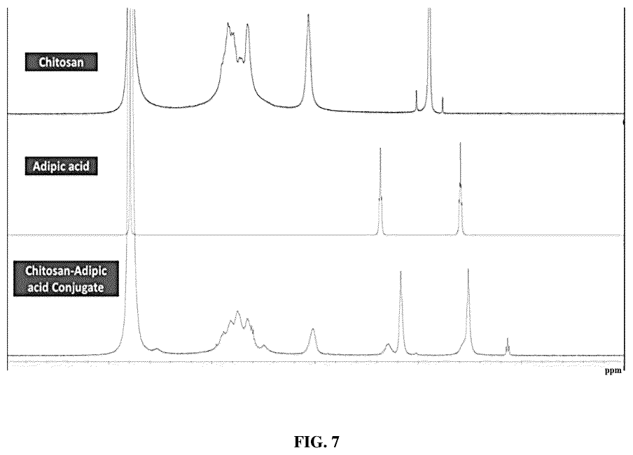

The molecular weight distribution of the synthesized chitosan-adipic acid conjugate from reaction EP1306-82b was determined by size-exclusion chromatography (SEC). Dextran standards were used to calibrate the SEC instrument. Chitosan and chitosan-adipic acid samples were injected into an Ultrahydrogel Linear column (Waters™) and eluted with 0.5 M acetic acid at flow rate 1.0 mL/min at 30° C. The eluted samples were detected by refractive index (RI) detector (FIG. 6). The molecular weight distribution was determined in terms of number average molecular weight (Mₙ), weight average molecular weight (M_{w}) and polydispersity index (PDI).

Table 2 summarizes the molecular weight distribution of chitosan and chitosan-adipic acid conjugate. The degree of polymerization (DP) of chitosan was estimated to be 1,000 from Mₙ value, where the chitosan was composed of 800-950 D-glucosamine units and 50-200 acetyl-D-glucosamine units. Taking the number of D-glucosamine units into account, the amount of primary amino groups was estimated to be 800-950. Conjugation of adipic acid to chitosan showed an increase in M_{w} for 40,000 amu, which was equivalent to grafting 274 molecules of adipic acid per chitosan chain. Such increase in the molecular weight also suggested no covalent inter-crosslinking between chitosan chains was observed, which would result in two-fold or more increase in the molecular weight distribution of the conjugate, as well as bimodal or multimodal molecular weight distribution on the SEC trace. Assuming one of the carboxyl groups on adipic acid molecule was activated by DMTMM coupling agent, the conjugation efficiency was 36%, with a grafting degree of 28-34%.

TABLE 2
Molecular weight distribution of chitosan and chitosan-adipic
acid conjugate prepared by DMTMM coupling reaction EP1306-82b.

| Molecular | | |
|---|---|---|
| weight | | Chitosan-adipic |
| distribution | Chitosan | acid conjugate |
| Mₙ (g/mol) | 180,000 | 200,000 |
| M_{w} (g/mol) | 260,000 | 300,000 |
| PDI | 1.44 | 1.52 |

The NMR spectrum of the chitosan-adipic acid conjugate showed a shift to lower ppm compared with unreacted chitosan and adipic acid. Peak shape at 3.49-3.88 ppm (N-glucosamine backbone) of the conjugate appeared to be different from that of N-glucosamine backbone of chitosan at 3.65-3.84 ppm. The changes and shifting of NMR signals suggested adipic acid was covalently attached to chitosan on the conjugate (FIG. 7). The resulting chitosan-adipic acid conjugates can be represented by the Formula IV, wherein x is 2-3, y is 1, z is 0.2, n is 274 (molar ratio of Formula I is 23.81%-31.25%); or x is 2, y is 1, z is 0.7, n is 274 (molar ratio of Formula I is 27%), and R¹ is —(C═O)(CH₂)₄CO₂H.

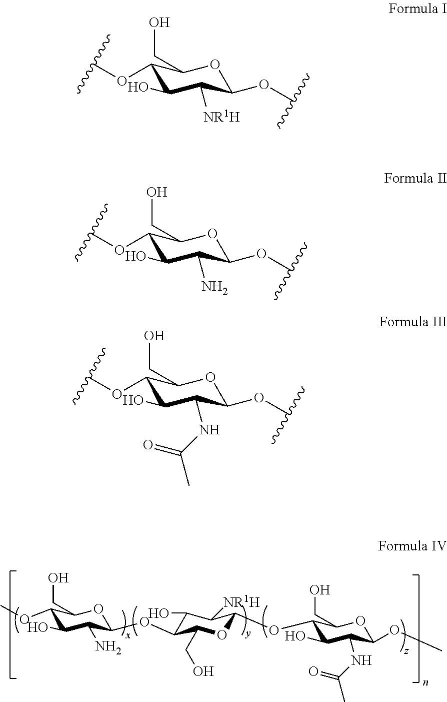

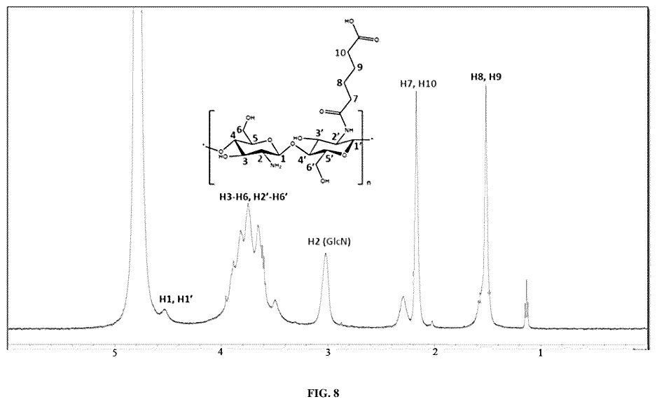

The grafting degree of adipic acid to chitosan was determined by integration of NMR spectrum of the conjugate (FIG. 8). The ratio between peak area at 3.02 ppm (GlcN, H2 on chitosan) and peak area at 2.17 ppm (conjugated adipic acid CH₂ groups) was 1:1.3384. The ratio was calculated as 1:0.33 (chitosan:adipic acid moiety) after the peak area was divided by the respective number of protons, which equaled to the ratio of NH₂ group and conjugated adipic acid (3:1). The result suggested a grafting degree of 25% for adipic acid. The grafting degree determined by the NMR spectrum correlated with the estimation of grafting degree calculated by molecular weight distribution according to SEC.

### 1.3 Solubility Test

The as-developed chitosan-adipic acid conjugate advantageously exhibited an improvement in water compatibility, which would be applicable for development of stable water-based formulation. The resulting chitosan conjugate is soluble in water and aqueous solution of pH<7, at a concentration of 0.01-2.5 wt. %, or 0.01%-0.1 wt. %. The resulting chitosan conjugate remained insoluble in aqueous solution of pH>7. The conjugate was completely soluble in water and acidic aqueous at pH 2, but became insoluble in alkaline aqueous at pH 9 and pH 12 (FIG. 9). The pH switchable solubility suggested the presence of unconjugated amino groups on the chitosan backbone, which contributed to hydrophobic nature due to reduction of electrostatic charges at high pH.

### Example 2—Preparation of Chitosan-Adipic Acid Conjugate in 500 g Reaction Scale by DMTMM Coupling Reaction

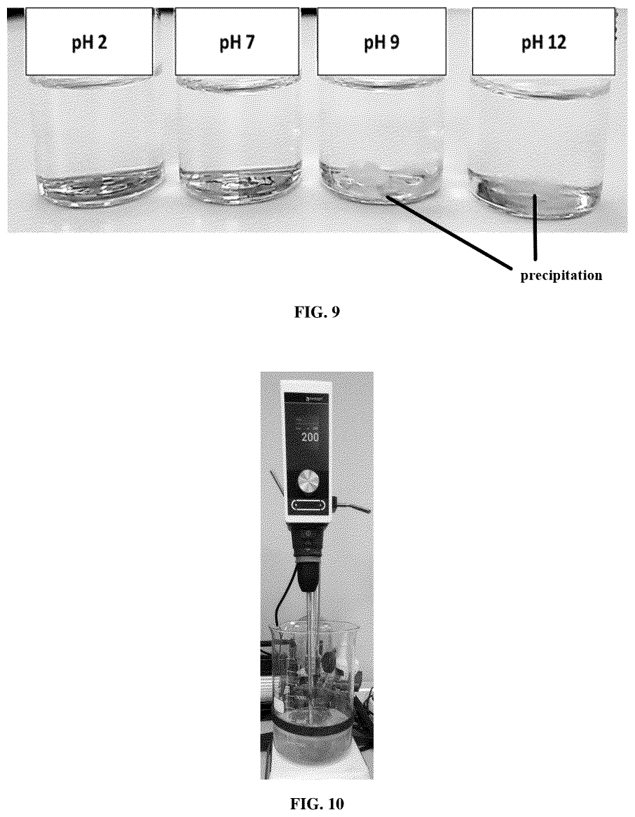

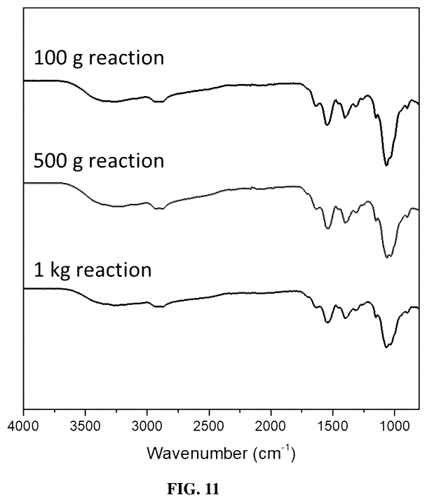

Aqueous dispersion of chitosan (degree of deacetylation=80-95%) was dissolved in aqueous dispersion of adipic acid by stirring for at least 30 minutes at room temperature. Aqueous dispersion of DMTMM was added to the chitosan/adipic acid solution and stirred by overhead stirrer for 4 hours at room temperature (FIG. 10). Composition of the reaction was summarized in Table 3. The formed chitosan-adipic acid conjugate was purified and obtained from ethanol precipitation. Acetone, isopropanol, or methanol were also applicable for purification of precipitation. The resulting resides were dried at room temperature, followed by 50-60° C. to obtain a white powder.

TABLE 3
The wt. % of reactants in preparation of chitosan-
adipic acid conjugate in 500 g reaction scale.

| 17% Chitosan | 3% Adipic | 11% DMTMM | |
|---|---|---|---|
| aqueous | acid aqueous | aqueous | Product |
| dispersion (%) | dispersion (%) | dispersion (%) | yield (%) |
| 12 | 73 | 15 | 75-80 |

### Example 3—Preparation of Chitosan-Adipic Acid Conjugate in at Least 1 kg Reaction Scale by DMTMM Coupling Reaction

Aqueous dispersion of chitosan (degree of deacetylation=80-95%) was dissolved in aqueous dispersion of adipic acid by stirring for at least 30 minutes at room temperature. Aqueous dispersion of DMTMM was added to the chitosan/adipic acid solution and stirred by overhead stirrer for 4 hours at room temperature (FIG. 10). Composition of the reactions were summarized in Table 4. The formed chitosan-adipic acid conjugate was purified and obtained from ethanol precipitation. Acetone, isopropanol, or methanol were also applicable for purification of precipitation. The resulting resides were dried at room temperature, followed by 50-60° C. to obtain a white powder.

TABLE 4
The wt. % of reactants in preparation of chitosan-adipic
acid conjugate in at least 1 kg reaction scale.

| 17% Chitosan | 3% Adipic | 11% DMTMM | |
|---|---|---|---|
| aqueous | acid aqueous | aqueous | Product |
| dispersion (%) | dispersion (%) | dispersion (%) | yield (%) |
| 12 | 73 | 15 | 75-80 |

### 3.2 Elucidation of the Resulting Chitosan-Adipic Acid Conjugate

Chitosan with molecular weight of 100,000-300,000 amu could be completely solubilized in adipic acid solution by simply mixing in small-scale reaction (i.e., within 100 g reaction). However, solubilization of chitosan powder in 1 kg reaction scale required few hours, which would lengthen the total preparation time of the conjugate, making large-scale production impractical and inefficient. Addition of all the powdered ingredients in the form of aqueous dispersion ensured complete solubilization of chitosan. The procedures could reduce the mixing time between chitosan and adipic acid from few hours to 30 minutes, before addition of DMTMM. The isolated chitosan-adipic acid conjugate was characterized by ATR-FTIR. Successful conjugation was evident by signal of C═O stretch at 1633 cm⁻¹ and amide N—H bending at 1541 cm⁻¹ (FIG. 11), which correlated to FTIR bands of the conjugate obtained from 100 g and 500 g reaction.

### Example 4—Stability of DMTMM-Mediated Reaction in Water

Aqueous dispersion of chitosan (Degree of deacetylation=80-95%) was dissolved in aqueous dispersion of adipic acid by stirring for at least 30 minutes at room temperature. Aqueous dispersion of DMTMM was added to the chitosan/adipic acid solution and stirred by overhead stirrer for 16 hours at room temperature. Samples of the reactions were collected from different time points and the crude product was precipitated from ethanol, followed by drying at 50-60° C. . . . The isolated products were characterized by ATR-FTIR. Composition of the reactions were summarized in Table 5.

TABLE 5
The wt. % of reactants for stability
study of DMTMM-mediated reaction.

| 17% Chitosan | 3% Adipic | 11% DMTMM |
|---|---|---|
| aqueous | acid aqueous | aqueous |
| dispersion (%) | dispersion (%) | dispersion (%) |
| 12 | 73 | 15 |

4.2 Elucidation of Chitosan-Adipic Acid Conjugate Isolated from Different Reaction Time Points

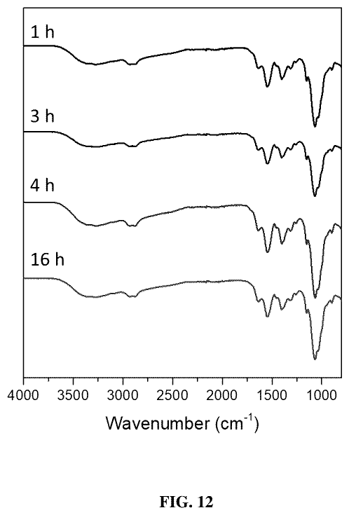

Chitosan conjugate isolated from 1-hour, 3-hour, 4-hour and 16-hour reactions was a white powder, suggesting no side reactions as the reaction was extended. FTIR spectra of the isolated products (FIG. 12) revealed the appearance of C═O stretch at 1633 cm⁻¹ and amide N—H bending at 1541 cm⁻¹ after reaction for 1 hour and persisted when the reaction was carried out after 16 hours. The FTIR bands correlated between all the time-points and no side products were observed on the spectra, suggesting the reaction was stable in water for up to at least 16 hours.

The amidation reaction mechanism involving adipic acid, chitosan and DMTMM is proposed in FIG. 13 (by-products not shown). The mole equivalent of adipic acid can be 2-6 fold in excess of DMTMM to ensure only one of the carboxyl ends of the adipic acid is activated by DMTMM, forming a DMTMM-activated ester with the release of N-methylmorpholinium (NMM) as by-product. The DMTMM-activated ester reacts with amino groups on chitosan, forming chitosan-adipic acid conjugate, where 1-hydroxy-3,5-dimethoxytriazine is formed as the second by-product. Both by-products are soluble in water, acetone or alcohol, which is selected from ethanol, isopropanol or methanol ethanol, can be removed along with unreacted adipic acid from solvent precipitation of the conjugate.

What is claimed is:

1. A method for preparing a chitosan conjugate, the method comprising: contacting chitosan, a dicarboxylic acid, and 4-(4,6-dimethoxy-1,3,5-triazin-2-yl)-4-methyl-morpholinium chloride (DMTMM) in an aqueous solvent thereby forming a reaction mixture comprising the chitosan conjugate, wherein the chitosan conjugate comprises a repeating unit of Formula I, 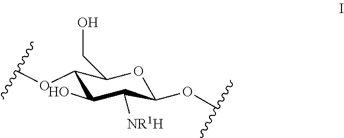
or a conjugate salt thereof, wherein
R¹ is —(C═O)(CH₂)mCO₂H; and
m is a whole number selected from 1-12.

2. The method of claim 1, wherein the dicarboxylic acid and DMTMM are present in the aqueous solvent at a molar ratio of 2-6:1, respectively.

3. The method of claim 1, wherein the dicarboxylic acid and DMTMM are present in the aqueous solvent at a molar ratio of 2.5-3.5:1, respectively.

4. The method of claim 1, wherein the chitosan, the dicarboxylic acid, DMTMM, and the aqueous solvent are contacted at a mass ratio of 0.5-2.5:0.5-3:0.5-2:93-98.5, respectively.

5. The method of claim 1, wherein the chitosan, the dicarboxylic acid, and the aqueous solvent are contacted at a mass ratio of about 2 to about 2.4 to about 1.6 to about 94, respectively.

6. The method of claim 1, wherein contacting comprises contacting the chitosan, the dicarboxylic acid, and the DMTMM at 20-40° C. for 1-20 hours.

7. The method of claim 5, wherein the step of contacting comprises contacting the chitosan, the dicarboxylic acid, and the DMTMM at about 25° C. for about four hours.

8. The method of claim 1, wherein contacting comprises contacting chitosan and the dicarboxylic acid in the aqueous solvent thereby forming a first solution and contacting the first solution and DMTMM.

9. The method of claim 1, wherein contacting comprises contacting a chitosan dispersion, a dicarboxylic acid dispersion, and a DMTMM dispersion thereby forming the reaction mixture, wherein the chitosan dispersion comprises chitosan and the aqueous solvent, the dicarboxylic acid dispersion comprises the dicarboxylic acid and the aqueous solvent, and the DMTMM dispersion comprises DMTMM and the aqueous solvent.

10. The method of claim 9, wherein the step of contacting comprises contacting the chitosan dispersion, the dicarboxylic acid dispersion, and the DMTMM dispersion at 20-40° C. for 1-20 hours.

11. The method of claim 9, wherein the step of contacting comprises contacting the chitosan dispersion, the dicarboxylic acid dispersion, and the DMTMM dispersion at about 25° C. for about four hours.

12. The method of claim 1, wherein m is 2-4.

13. The method of claim 7, wherein m is 4.

14. The method of claim 11, wherein m is 4.

15. The method of claim 1, wherein the chitosan conjugate further comprises a repeating unit of Formula II and optionally a repeating unit of Formula III,

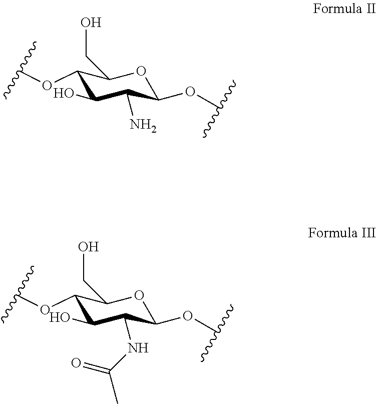

16. The method of claim 15, wherein the repeating unit of Formula I accounts for 20-40% based on a total number of the repeating units of Formula I, repeating units of Formula II, and optionally the repeating units of Formula III in the chitosan conjugate.

17. The method of claim 1, wherein the chitosan conjugate has a weight average molecular weight of about 300,000 amu.

18. The method of claim 1, wherein the chitosan conjugate has a polydispersity index (PDI) of about 1.52.

19. The method of claim 1 further comprising the step of contacting the reaction mixture with an organic solvent thereby precipitating the chitosan conjugate and collecting the precipitated chitosan conjugate.

20. The method of claim 17, wherein the organic solvent is selected from the group consisting of an alcohol, a ketone, and mixtures thereof.
